(19) United States
(12) Patent Application Publication
(10) Pub. No.: US 2025/0156357 A1
(43) Pub. Date: May 15, 2025

(54) SERVER MOTHERBOARD CONTROL SYSTEM

(71) Applicants: SQ TECHNOLOGY(SHANGHAI) CORPORATION, Shanghai (CN); INVENTEC CORPORATION, Taipei City (TW)

(72) Inventors: Li-Hong HUANG, Shanghai City (CN); Zhenwei LI, Shanghai City (CN); Hong-Chou LIN, Taipei City (TW); YU-FAN CHEN, Taipei City (TW)

(73) Assignees: SQ TECHNOLOGY(SHANGHAI) CORPORATION, Shanghai (CN); INVENTEC CORPORATION, Taipei City (TW)

(21) Appl. No.: 18/406,992

(22) Filed: Jan. 8, 2024

(30) Foreign Application Priority Data
Nov. 13, 2023 (CN) 202311506861.2

(51) Int. Cl. G06F 13/40

(52) U.S. Cl. CPC G06F 13/4031; G06F 2213/0016

(57) ABSTRACT

A server motherboard control system includes a device to be controlled, an arbitration component and two control components. The arbitration component is connected to the device to be controlled. The first/second control component is connected to the arbitration component and is configured to control the device to be controlled through the arbitration component, and the first/second control component has a first/second pin respectively. The first control component and the second control component are connected to each other through the first pin and the second pin. The first control component is configured to have access to the arbitration component when determining that the second control component is in a hung state through the first pin. The second control component is configured to have access to the arbitration component when determining that the first control component is in a hung state through the second pin.

### CROSS-REFERENCE TO RELATED APPLICATIONS

This non-provisional application claims priority under 35 U.S.C. § 119(a) on Patent Application No(s). 202311506861.2 filed in China on Nov. 13, 2023, the entire contents of which are hereby incorporated by reference.

### BACKGROUND

### 1. Technical Field

This disclosure relates to a server motherboard control system.

### 2. Related Art

For a motherboard, a baseboard management controller (BMC) can be used to control multiple components. On some new architectures, two or more baseboard management controllers may be installed on one motherboard. Therefore, how to perform collaborative control with multiple baseboard management controllers on one motherboard is a problem pending to be solved in this field.

### SUMMARY

Accordingly, this disclosure provides a server motherboard control system.

According to one or more embodiment of this disclosure, a server motherboard control system includes a device to be controlled, an arbitration component, a first control component and a second control component. The arbitration component is connected to the device to be controlled. The first control component is connected to the arbitration component and is configured to control the device to be controlled through the arbitration component, and the first control component has a first pin. The second control component is connected to the arbitration component and is configured to control the device to be controlled through the arbitration component, and the second control component has a second pin. The first control component and the second control component are connected to each other through the first pin and the second pin. The first control component is configured to have access to the arbitration component when determining that the second control component is in a hung state through the first pin. The second control component is configured to have access to the arbitration component when determining that the first control component is in a hung state through the second pin.

In view of the above description, the server motherboard control system of the present disclosure provides an architecture with two baseboard management controllers on a motherboard. The two baseboard management controllers are connected to each other through specific pins and correspond to two control nodes respectively, and are switched into a control line through an arbitration component. On this basis, the present disclosure may ensure that the two baseboard management controllers do not interfere with each other when controlling the device to be controlled, and ensure that even if one of the baseboard management controllers is in a hung state, control rights can still be switched in a smooth way.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a server motherboard control system according to an embodiment of the present disclosure;

FIG. 2 is a block diagram of a server motherboard control system according to another embodiment of the present disclosure;

FIG. 3 is a block diagram illustrating the detailed configuration of a server motherboard control system according to an embodiment of the present disclosure; and

FIG. 4 is a block diagram of a server motherboard control system according to still another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

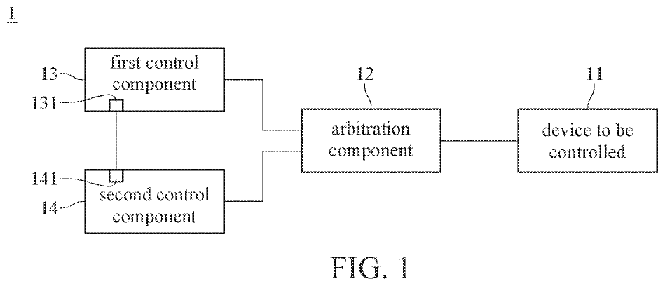

Please refer to FIG. 1 which is a block diagram of a server motherboard control system according to an embodiment of the present disclosure. As shown in FIG. 1, a server motherboard control system 1 includes a device to be controlled 11, an arbitration component 12, a first control component 13 and a second control component 14. The arbitration component 12 is connected to the device to be controlled 11. The first control component 13 is connected to the arbitration component 12 and is configured to control the device to be controlled 11 through the arbitration component 12, and the first control component 13 has a first pin 131. The second control component 14 is connected to the arbitration component 12 and is configured to control the device to be controlled 11 through the arbitration component 12, and the second control component 14 has a second pin 141. The first control component 13 and the second control component 14 are connected to each other through the first pin 131 and the second pin 141. The first control component 13 is configured to have access to the arbitration component 12 when determining that the second control component 14 is in a hung state through the first pin 131. The second control component 14 is configured to have access to the arbitration component 12 when determining that the first control component 13 is in a hung state through the second pin 141.

In the present embodiment, the device to be controlled 11 may be a device with speed control requirements, such as a cooling fan device. For example, the device to be controlled 11 may include a fan, and the arbitration component 12 may be connected to the power supply unit of the fan. The first control component 13 and the second control component 14 may be two independent baseboard management controllers (BMC). Both the first control component 13 and the second control component 14 may be configured to adjust the pulse width modulation (PWM) signal of the device to be controlled 11 to control the output power of the device to be controlled 11. Regarding the control circuit, the first control component 13 and the second control component 14 respectively belong to different control nodes. The first control component 13 and the second control component 14 are switched into one control circuit through the arbitration component 12. Specifically, the first control component 13 may be connected to the arbitration component 12 through a first inter-integrated circuit (I2C), the second control component 14 may be connected to the arbitration component 12 through a second inter-integrated circuit, and the arbitration component 12 may be connected to the device to be controlled 11 through a third inter-integrated circuit. The arbitration component 12 may be a switching component (I2C switch) based on an inter-integrated circuit, such as a PCA9641 arbitration component.

The first control component 13 and the second control component 14 are connected to each other through the first pin 131 and the second pin 141. Specifically, the first pin 131 and the second pin 141 may be general-purpose input/output (GPIO) pins. In the present embodiment, the first control component 13 is preset or defaulted to have the initial control right of the device to be controlled 11. That is, at the beginning, the first control component 13 has access to the arbitration component 12 and controls the device to be controlled 11 through the arbitration component 12. The second control component 14 may detect whether the first control component 13 is in a hung state through the second pin 141. When the second control component 14 determines that the first control component 13 is in a hung state, the second control component 14 may have access to the arbitration component 12 to replace the first control component 13 to control the device to be controlled 11. Similarly, under a condition that the second control component 14 has control right of the device to be controlled 11, when the first control component 13 determines that the second control component 14 is in a hung state, the first control component 13 may have access to the arbitration component 12 to replace the second control component 14 to control the device to be controlled 11.

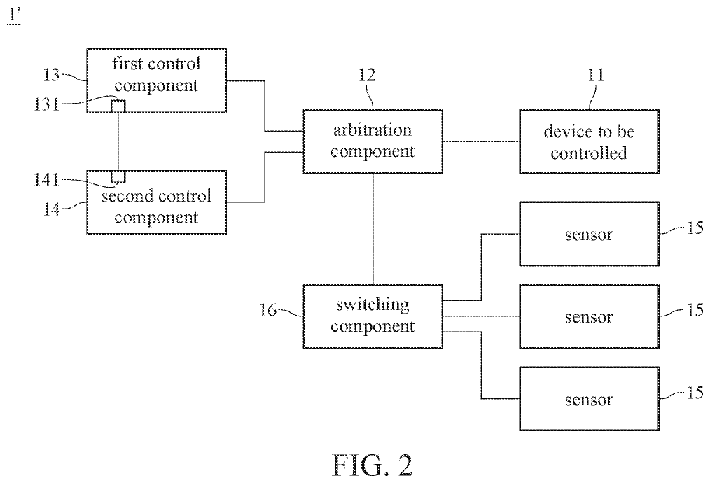

Please refer to FIG. 2 which is a block diagram of a server motherboard control system according to another embodiment of the present disclosure. As shown in FIG. 2, In addition to the device to be controlled 11, the arbitration component 12, the first control component 13 (including the first pin 131) and the second control component 14 (including the second pin 141) that are the same as the embodiment in FIG. 1, the server motherboard control system 1′ further includes a plurality of sensors 15 and a switching component 16. The switching component 16 is connected to the plurality of sensors 15 and the arbitration component 12. In the present embodiment, the first control component 13 and the second control component 14 are further configured to switch a plurality of connection pins of the switching component 16 according to a specified signal to obtain a sensing signal of one of the plurality of sensors 15. The switching component 16 may be a multi-channel inter-integrated circuit switching component, particularly an eight-channel inter-integrated circuit switching component, such as a PCA9548 switching component. In the present embodiment, the plurality of sensors 15 may be disposed at different locations on the motherboard, and are configured to obtain temperature information at various locations on the motherboard to obtain temperature information of various locations of the motherboard (such as temperature information at the EFUSE pin and TEMP pin on each board card). The plurality of sensors 15 may be connected to the switching component 16 through various hardware interfaces (eg, PDB, M.2, AIC riser, GPU riser, FCB, etc.).

The first control component 13 and the second control component 14 may obtain the temperature information of the motherboard obtained by each sensor 15 through the arbitration component 12 and the switching component 16, and perform speed control operations on the device to be controlled 11 (such as a fan device) based on this temperature information.

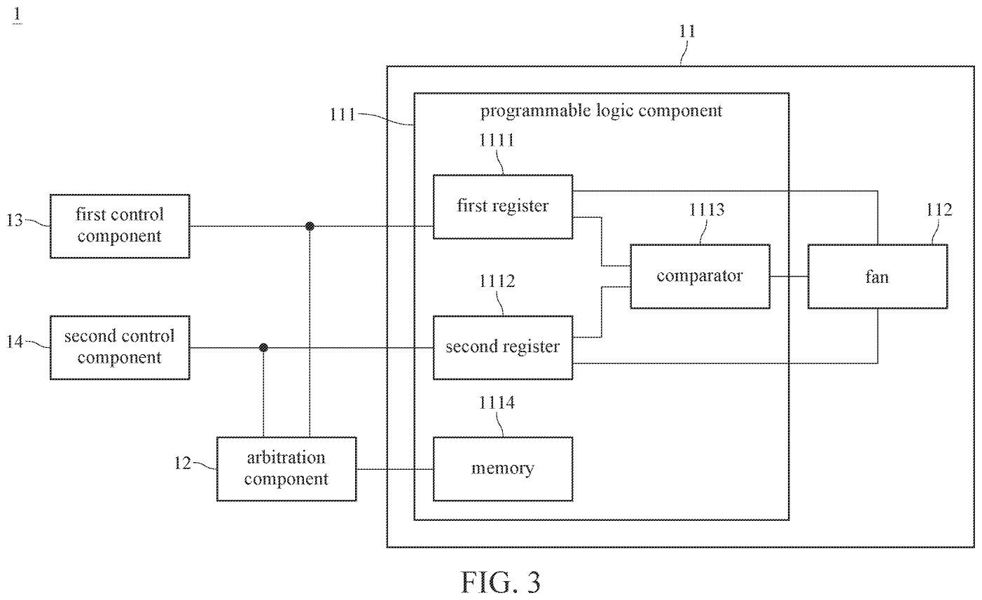

Please refer to FIG. 3 which is a block diagram illustrating the detailed configuration of a server motherboard control system according to an embodiment of the present disclosure. As shown in FIG. 3, in the present embodiment, the device to be controlled 11 controlled by the first control component 13 and the second control component 14 of the server motherboard control system 1 through the arbitration component 12 may include a programmable logic component 111 and a fan 112. The programmable logic component 111 includes a first register 1111, a second register 1112, a comparator 1113 and a memory 1114. The first register 1111 is connected to the first control component 13 and the arbitration component 12 through a first inter-integrated circuit. The second register 1112 is connected to the second control component 14 and the arbitration component 12 through a second inter-integrated circuit. The comparator 1113 is connected to the first register 1111 and the second register 1112, and is configured to compare a first pulse width modulation of the first register 1111 with a second pulse width modulation of the second register 1112, and use the larger one of the first pulse width modulation and the second pulse width modulation as the control signal of the fan 112 of the device to be controlled 11. In addition, in the present embodiment, the first control component 13 and the second control component 14 may be further configured to perform a firmware update operation on the memory 1114. For example, the control logic for comparing the first pulse width modulation and the second pulse width modulation of the first register 1111 and the second register 1112 by the comparator 1113 may be written in the memory 1114. Specifically, the memory 1114 may be a flash memory, an electronically-erasable programmable read-only memory (EEPROM), or a programmable read-only memory (PROM), etc. in the programmable logic component 111.

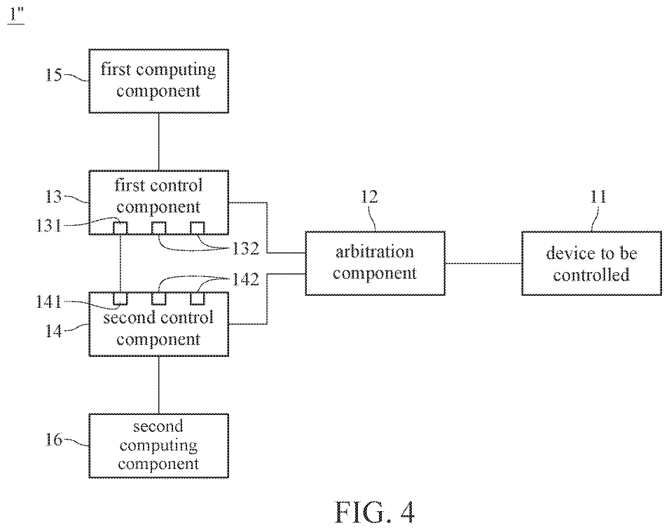

Please refer to FIG. 4 which is a block diagram of a server motherboard control system according to still another embodiment of the present disclosure. As shown in FIG. 4, in the server motherboard control system 1″ of the present embodiment, the first control component 13 further includes a plurality of first spare pins 132 in addition to the first pin 131, and the second control component 14 further includes a plurality of second spare pins 142 in addition to the second pin 141, wherein the first pin 131, the second pin 141, the first spare pins 132 and the second spare pins 142 are general-purpose input and output pins. By the first spare pins 132 and second spare pins 142 that are additionally disposed, other special functions may be reserved for subsequent development, making the overall architecture more flexible.

In addition, in the present embodiment, in addition to the device to be controlled 11, the arbitration component 12, the first control component 13 and the second control component 14, the server motherboard control system 1″ may further include a first computing component 17 and a second computing component 18, wherein the first control component 13 is connected to the first computing component 17, and the second control component 14 is connected to the second computing component 18. Specifically, the first computing component 17 and the second computing component 18 may be two central processing units (CPU), and the first control component 13 and the second control component 14 respectively perform data transmission with the first computing component 17 and the second computing component 18.

The server motherboard control system of the embodiments described above may be based on a Birch stream platform architecture, and is particularly suitable for the system fan speed control requirements of Granite Rapids AP under the dual-socket (2×1S) architecture (that is, each socket is an independent system). The server motherboard control system may also meet the speed control requirements of two baseboard management controllers in two nodes under different platforms for the same fan backplane in the system.

In view of the above description, the server motherboard control system of the present disclosure provides an architecture with two baseboard management controllers on a motherboard. The two baseboard management controllers are connected to each other through specific pins and correspond to two control nodes respectively, and are switched into a control line through an arbitration component. On this basis, the present disclosure may ensure that the two baseboard management controllers do not interfere with each other when controlling the device to be controlled, and ensure that even if one of the baseboard management controllers is in a hung state, control rights can still be switched in a smooth way. In addition, by using two baseboard management controllers to read the power consumption and online update of a programmable logic component, the overall configuration can further simplified.

What is claimed is:

1. A server motherboard control system, comprising:
a device to be controlled;
an arbitration component connected to the device to be controlled;
a first control component connected to the arbitration component and configured to control the device to be controlled through the arbitration component, and the first control component having a first pin;
a second control component connected to the arbitration component and configured to control the device to be controlled through the arbitration component, and the second control component having a second pin,
wherein the first control component and the second control component are connected to each other through the first pin and the second pin, the first control component is configured to have access to the arbitration component when determining that the second control component is in a hung state through the first pin, and the second control component is configured to have access to the arbitration component when determining that the first control component is in a hung state through the second pin.

2. The server motherboard control system of claim 1, wherein the device to be controlled comprises a fan, and the arbitration component is connected to a power supply unit of the fan.

3. The server motherboard control system of claim 1, wherein the first control component is connected to the arbitration component through a first inter-integrated circuit, the second control component is connected to the arbitration component through a second inter-integrated circuit, and the arbitration component is connected to the device to be controlled through a third inter-integrated circuit.

4. The server motherboard control system of claim 1, further comprising:
a plurality of sensors; and
a switching component connected to the plurality of sensors and the arbitration component,
wherein the first control component and the second control component are further configured to switch a plurality of connection pins of the switching component according to a specified signal to obtain a sensing signal of one of the plurality of sensors.

5. The server motherboard control system of claim 4, wherein the switching component is a multi-channel inter-integrated circuit switching component.

6. The server motherboard control system of claim 1, wherein the device to be controlled comprises a programmable logic component, and the programmable logic component comprises:
a first register connected to the first control component and the arbitration component through a first inter-integrated circuit;
a second register connected to the second control component and the arbitration component through a second inter-integrated circuit; and
a comparator connected to the first register and the second register, and configured to compare a first pulse width modulation of the first register with a second pulse width modulation of the second register, and use a larger one of the first pulse width modulation and the second pulse width modulation as a control signal of the device to be controlled.

7. The server motherboard control system of claim 6, wherein the programmable logic component further comprises a memory connected to the arbitration component,
wherein first control component and the second control component are further configured to perform a firmware update operation on the memory.

8. The server motherboard control system of claim 1, wherein the first control component further comprises a plurality of first spare pins in addition to the first pin, and the second control component further comprises a plurality of second spare pins in addition to the second pin, and the first pin, the second pin, the plurality of first spare pins and the plurality of second spare pins are general-purpose input and output pins.

9. The server motherboard control system of claim 1, wherein the first control component is further connected to a first computing component, and the second control component is further connected to a second computing component.

10. The server motherboard control system of claim 1, wherein a motherboard of the server motherboard control system is based on a Birch stream platform architecture.
